(19) United States
(12) Patent Application Publication
(10) Pub. No.: US 2026/0361604 A1
(43) Pub. Date: Nov. 12, 2026

(54) METHOD AND APPARATUS FOR SLICE LEVEL RESOURCE MANAGEMENT

(71) Applicant: Huawei Technologies Co., Ltd., Shenzhen (CN)

(72) Inventors: Mohamed Faraj Moftah Alzenad, Ottawa (CA); Nimal Gamini Senarath, Ottawa (CA)

(21) Appl. No.: 19/648,618

(22) Filed: Apr. 15, 2026

Related U.S. Application Data
(63) Continuation of application No. PCT/CN2024/091241, filed on May 6, 2024.
(60) Provisional application No. 63/591,232, filed on Oct. 18, 2023.

(51) Int. Cl. H04L 41/0895; H04L 41/16; H04W 8/22; H04W 28/02

(52) U.S. Cl. CPC H04L 41/0895; H04L 41/16; H04W 8/22; H04W 28/0268

(57) ABSTRACT

A method for allocating resources for a network slice is provided. A request for creation of a network slice is received by a resource management service. The resource management service determines what network services are required to satisfy the request and how many resources are required to satisfy the request. The resource management service may then configure an infrastructure service to provide the required resources for the network slice.

### CROSS-REFERENCE TO RELATED APPLICATIONS

This application is a continuation of International Patent Application No. PCT/CN2024/091241, filed on May 6, 2024, which claims the benefits of U.S. Provisional Application No. 63/591,232, filed on Oct. 18, 2023, the disclosures of which are hereby incorporated by reference in their entireties.

### TECHNICAL FIELD

The present disclosure relates to wireless communications. Specifically, the present disclosure relates to a method and apparatus for resource management at network slices.

### BACKGROUND

The design of 6G or future wireless networks should seek to accommodate multiple emerging technologies and trends, such as new network infrastructures, such as cloud native infrastructure, technologies such as Artificial Intelligence (AI) and Blockchain, new apps and services, such as AI services and Data sensing services, and more open and collaborative operation modes.

Other requirements for future networks include increased privacy and trustworthiness, simplified standardization, rapid deployment, and support for Anything as a Service (XaaS).

Moreover, the 6G system network architecture should support 6G services developed by third parties by providing an open ecosystem, and enable improved trustworthiness management.

### SUMMARY

It is an object of the present disclosure to provide slice level resource management for wireless communications.

In a first aspect, there is provided a method at a network element comprising: receiving, from a slice customer, a request for creation of a network slice; identifying network services required to satisfy the request, wherein the network services include an Artificial Intelligence (AI) provisioning service, a data collection service and a historical learning service; preparing service information required for a service manager to evaluate resource requirements for the slice, the service information comprising an order of the network services to be executed; sending the service information to the service manager, wherein the service manager instructs network entities to perform the network services according to the order of execution of the network services; receiving, from the service manager, AI algorithms, historical information and data from the network services; running the AI algorithms utilizing the received historical information and data from the network services to determine an amount of resources required to satisfy the request; sending, to an Infrastructure Manager, a configuration request, the configuration request comprising the amount of resources; receiving, from the Infrastructure Manager, a response to the configuration request; and sending, to the slice customer, a response to the request.

According to an embodiment of the first aspect, the slice customer is an Anything as a Service (XaaS) service.

According to another embodiment of the first aspect, the network services further comprise at least one of connectivity services, service management services and simulation services.

According to yet another embodiment of the first aspect, the method further comprises requesting, from each of the network services, available network service types, capability information, and resource availability.

According to yet another embodiment of the first aspect, the method further comprises validating, based on the received available network service type and capability information for the network services, that the request may be satisfied by the network services.

According to yet another embodiment of the first aspect, the method further comprises selecting a strategy, the strategy comprising at least one of: a first selection of a model-based approach or a data-based approach, a second selection of a centralized approach or a distributed approach, a third selection of whether to use clustering, a fourth selection of resource allocation algorithms, and a fifth selection of a historical learning analysis.

According to yet another embodiment of the first aspect, the configuration request comprises an average volume of traffic for each access point and each network function, a Quality of Service (QoS) parameter, and a time indication for the execution of the service.

According to yet another embodiment of the first aspect, the method further comprises sending, to a simulation platform, a simulation request to simulate the network slice, the request comprising network element identifiers, network element specifications, in-network data processing types, service requirements to be satisfied by the network slice, and resource allocation decisions; and receiving a response to the simulation request, the response comprising an indication of an expected performance of the resource assignment.

According to yet another embodiment of the first aspect, selecting the strategy comprises requesting information of one or more algorithms from the AI provisioning service, wherein the information comprises an algorithm identifier, an algorithm type, a complexity, parameters, and run time information.

According to yet another embodiment of the first aspect, the method further comprises receiving, from the AI provisioning service, an indication that the algorithm is not available; and requesting the algorithm information from an external library.

According to yet another embodiment of the first aspect, the service information further comprises at least one of a service identifier, an intent for the service, network services tasks identifiers, a temporal and spatial validity, a reusability indicator, a data type, a data source and location, a collection time, a data processing method, an output data granularity, a resources type, a temporal resource availability, a resource cost and budget, a resource sharing indicator, an AI algorithm ID, an algorithm type, a structure, parameters, and a complexity.

According to yet another embodiment of the first aspect, the order of the network services is prepared according to a slice blueprint.

According to yet another embodiment of the first aspect, the method further comprises preparing an online testbed for testing whether the amount of resources is sufficient to satisfy slice requirements.

According to yet another embodiment of the first aspect, the simulation platform comprises digital representations of network functions and the network entities, the digital representations of the network entities comprising a current state of the network entities.

According to yet another embodiment of the first aspect, the method further comprises receiving, from the AI provisioning service, AI algorithms; receiving, from a data collection service, network data; and receiving, from a historical learning service, historical information and analytics.

According to yet another embodiment of the first aspect, at least one network service of the network services is provided by an associated network function.

According to yet another embodiment of the first aspect, the connectivity services provide exchange and transport of messages and data among network functions.

According to yet another embodiment of the first aspect, the service management services provide coordination of execution of network services according to the order of the network services.

According to yet another embodiment of the first aspect, the simulation services are provided by a simulation service entity for testing a performance of the network slice.

According to yet another embodiment of the first aspect, the method further comprises rejecting the request upon determining that the request cannot be satisfied.

According to a second aspect, there is provided a network element comprising one or more processors configured to implement the method of any embodiment of the first aspect. In one embodiment, the network element comprises one or more processors, and a memory having instructions stored thereon which, when executed by the one or more processors, cause the network element to implement the method of any embodiment of the first aspect.

According to a third aspect, there is provided computer readable medium having stored thereon computer readable instructions, which when executed by one or more processors, cause a device to perform the method of any embodiment of the first aspect.

### BRIEF DESCRIPTION OF THE DRAWINGS

The present disclosure will be better understood with reference to the drawings in which:

FIG. 1 is a graphical representation of a networking environment according to at least one embodiment of the present disclosure.

FIG. 2 is a graphical representation of a communications system according to at least one embodiment of the present disclosure.

FIG. 3 is a graphical representation of an electronic device communicating with a base station according to at least one embodiment of the present disclosure.

FIG. 4 is a block diagram of a device according to at least one embodiment of the present disclosure.

FIG. 5 is a block diagram of a structure for a 6G system according to at least one embodiment of the present disclosure.

FIG. 6 is a block diagram of a functional architecture of slice level RMaaS according to at least some embodiments of the present disclosure.

FIG. 7 is a flow diagram of a method for network slice provisioning according to at least one embodiment of the present disclosure.

FIG. 8 is a flow diagram of a method for selecting a resource management strategy according to at least one embodiment of the present disclosure.

FIG. 9 is a flow diagram of a method for processing a request for resource management according to at least one embodiment of the present disclosure.

FIG. 10 is a flow diagram of a method for resource evaluation according to at least some embodiments of the present disclosure.

FIG. 11 is a block diagram of an exemplary device for implementing embodiments of the present disclosure.

### DETAILED DESCRIPTION

The present disclosure is directed to a method and apparatus for slice level resource management.

Resource management (RM) in 6G networks can support two types of services: slice level RM service, and device level RM service. At the slice level, 6G RM as a service (RMaaS) provides RM services such as resource reservations during slice provisioning and run-time resource updates to RM customers such as 6G XaaS services. RMaaS may consider several factors, such as service requirements, resource cost, resource availability, and the like.

At the device level, RMaaS is responsible for determining and instantiating RM schemes for users and infrastructures in the Radio Access Network.

According to some embodiments of the present disclosure, there is provided a functional architecture of the 6G slice level RMaaS, including what type of slice level RM services may be provided, functions involved in the RM service, and the services provided by these functions.

During slice provisioning, slice level RMaaS functions interact in order to determine the required resources and policies for a network slice to satisfy customers' end-to-end service requirements. For example, an RMaaS may consider UE distribution statistics over a large area, such as peak data rate, average data rate, peak traffic demand, average traffic demand, and UE distributions, amongst others.

The RMaaS may convert customers' requirements to an appropriate representation suitable for resource evaluation. For example, the RMaaS may divide a service area into grids and represent the service requirements as grid-based requirements.

Due to resource limitations and the dynamic nature of demand, overprovisioning a network slice to satisfy service requirements may be an inefficient resource allocation policy. Service demand (e.g., traffic demand) is dynamic in nature and often unpredictable precisely during the provisioning phase. While the network is running, the service demand, and hence resource requirement, may decrease in comparison to what was initially agreed upon in a service level agreement. This results in resources reserved for the network slice not being fully utilized. Accordingly, keeping these resources for the running network slice is not a cost-efficient decision. Therefore, there is a need to update network slice resources during run-time while satisfying customer demand.

6G RMaaS requires several services and functions in order to provide RM service to a customer. However, no functional architecture is defined for 6G RMaaS. Accordingly, as further described herein, embodiments of the present disclosure may comprise:
Identifying the functionalities of a 6G RMaaS which are needed during slice provisioning and during run-time.
Providing details of the services provided by the identified functions and identify service requirements such as service input, service output, and service consumer.
Providing a message flow for interactions between RMaaS functions and other 6G XaaS to provision a slice of the network with resources.

Embodiments described in the present disclosure may be used in conjunction with, or part of, an operating environment, which is now described.

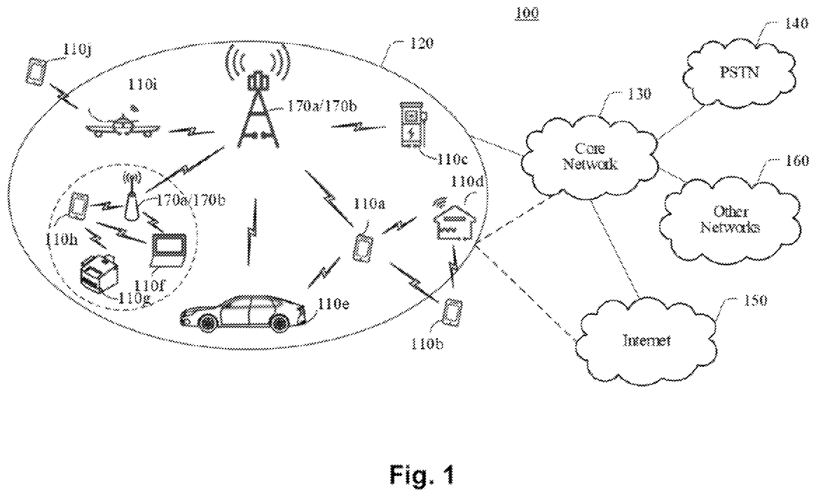

Referring to FIG. 1, as an illustrative and non-limiting example, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electronic devices (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

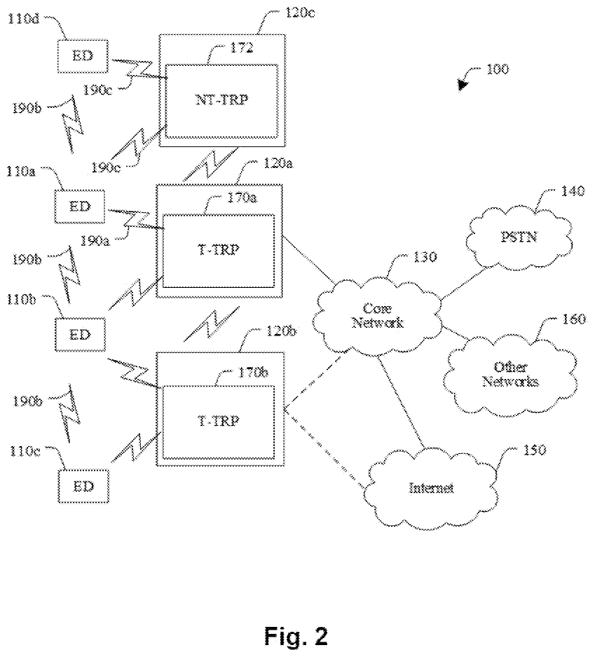

Reference is now made to FIG. 2, which illustrates an example communication system 100. In general, the communication system 100 enables multiple wireless or wired elements to communicate data and other content. The purpose of the communication system 100 may be to provide content, such as voice, data, video, and/or text, via broadcast, multicast, groupcast, unicast, and the like. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, and the like). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150, and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a,170b and NT-TRP 172, the Internet 150, the core network 130, the PSTN 140, the other networks 160, or any combination of the preceding. In some examples, ED 110a may communicate an uplink and/or downlink transmission over a terrestrial air interface 190a with T-TRP 170a. In some examples, the EDs 110a, 110b, 110c, and 110d may also communicate directly with one another via one or more sidelink air interfaces 190b. In some examples, ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), or single-carrier FDMA (SC-FDMA, also known as discrete Fourier transform spread OFDMA, DFT-s-OFDMA) in the air interfaces 190a and 190b. The air interfaces 190a and 190b may utilize other higher dimension signal spaces, which may involve a combination of orthogonal and/or non-orthogonal dimension.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 172 for multicast transmission.

The RANs 120a and 120b are in communication with the core network 130 to provide the EDs 110a, 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a, 110b, and 110c or both, and (ii) other networks (such as the PSTN 140, the Internet 150, and the other networks 160). In addition, some or all of the EDs 110a, 110b, and 110c may include functionality for communicating with different wireless networks over different wireless links using different wireless technologies and/or protocols. Instead of wireless communication (or in addition thereto), the EDs 110a, 110b, and 110c may communicate via wired communication channels to a service provider or switch (not shown), and to the Internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a, 110b, and 110c may be multimode devices capable of operation according to multiple radio access technologies, and incorporate multiple transceivers necessary to support such.

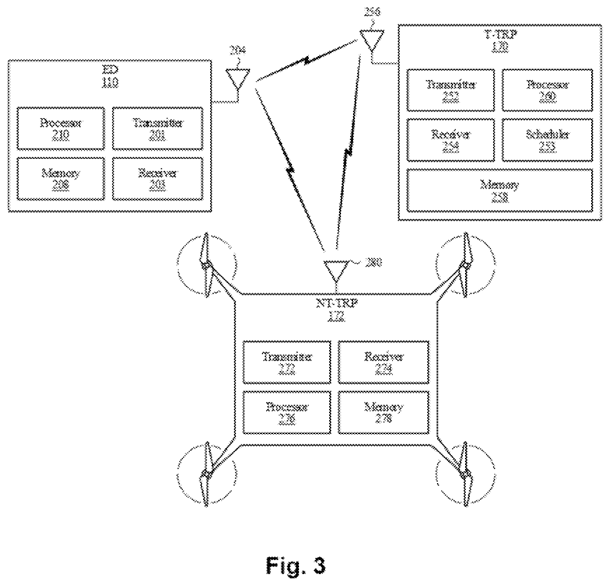

FIG. 3 illustrates another example of an ED 110 and a base station 170a, 170b and/or 170c. The ED 110 is used to connect persons, objects, and machines, amongst others. The ED 110 may be widely used in various scenarios including, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, amongst others.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, wearable devices (such as a watch, a pair of glasses, head mounted equipment, and the like), an industrial device, or an apparatus in (e.g. communication module, modem, or chip) or comprising the foregoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated to avoid congestion in the drawing. One, some, or all of the antennas 204 may alternatively be panels. The transmitter 201 and the receiver 203 may be integrated, e.g. as a transceiver. The transceiver is configured to modulate data or other content for transmission by at least one antenna 204 or Network Interface Controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the Internet 150 in FIG. 2). The input/output devices or interfaces permit interaction with a user or other devices in the network. Each input/output device or interface includes any suitable structure for providing information to or receiving information from a user, and/or for network interface communications. Suitable structures include, for example, a speaker, microphone, keypad, keyboard, display, touch screen, and the like.

The ED 110 includes the processor 210 for performing operations including those operations related to preparing a transmission for uplink transmission to the NT-TRP 172 and/or the T-TRP 170; those operations related to processing downlink transmissions received from the NT-TRP 172 and/or the T-TRP 170; and those operations related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g. beam angle information (BAI), received from the T-TRP 170. In some embodiments, the processor 210 may perform operations relating to network access (e.g. initial access) and/or downlink synchronization, such as operations relating to detecting a synchronization sequence, decoding and obtaining the system information, and the like. In some embodiments, the processor 210 may perform channel estimation, e.g. using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201, and the processing components of the receiver 203 may each be implemented by the same or different one or more processors that are configured to execute instructions stored in a memory (e.g. in the memory 208). Alternatively, some or all of the processor 210, the processing components of the transmitter 201, and the processing components of the receiver 203 may each be implemented using dedicated circuitry, such as a programmed field-programmable gate array (FPGA), an application-specific integrated circuit (ASIC), or a hardware accelerator such as a graphics processing unit (GPU) or an artificial intelligence (AI) accelerator.

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a terrestrial node, a terrestrial network device, a terrestrial base station, a base band unit (BBU), a remote radio unit (RRU), an active antenna unit (AAU), a remote radio head (RRH), a central unit (CU), a distributed unit (DU), a positioning node, among other possibilities. The T-TRP 170 may be a macro BS, a pico BS, a relay node, a donor node, or the like, or combinations thereof. The T-TRP 170 may refer to the foregoing devices or refer to apparatus (e.g. a communication module, a modem, or a chip) in the foregoing devices.

In some embodiments, the parts of the T-TRP 170 may be distributed. For example, some of the modules of the T-TRP 170 may be located remote from the equipment that houses the antennas 256 for the T-TRP 170, and may be coupled to the equipment that houses the antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses the antennas 256 of the T-TRP 170. The modules may also be coupled to other T-TRPs. In some embodiments, the T-TRP 170 may actually be a plurality of T-TRPs that are operating together to serve the ED 110, e.g. through the use of coordinated multipoint transmissions.

The T-TRP 170 includes at least one transmitter 252 and at least one receiver 254 coupled to one or more antennas 256. Only one antenna 256 is illustrated to avoid congestion in the drawing. One, some, or all of the antennas 256 may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to the NT-TRP 172, and processing a transmission received over backhaul from the NT-TRP 172. Processing operations related to preparing a transmission for downlink or backhaul transmission may include operations such as encoding, modulating, precoding (e.g. multiple input multiple output (MIMO) precoding), transmit beamforming, and generating symbols for transmission. Processing operations related to processing received transmissions in the uplink or over backhaul may include operations such as receive beamforming, demodulating received symbols, and decoding received symbols. The processor 260 may also perform operations relating to network access (e.g. initial access) and/or downlink synchronization, such as generating the content of synchronization signal blocks (SSBs), generating the system information, and the like. In some embodiments, the processor 260 also generates an indication of beam direction, e.g. BAI, which may be scheduled for transmission by a scheduler 253. The processor 260 performs other network-side processing operations described herein, such as determining the location of the ED 110, determining where to deploy the NT-TRP 172, and the like. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Signaling may be transmitted in a physical layer control channel, e.g. a physical downlink control channel (PDCCH), in which case the signaling may be known as dynamic signaling. Signaling transmitted in a downlink physical layer control channel may be known as Downlink Control Information (DCI). Signaling transmitted in an uplink physical layer control channel may be known as Uplink Control Information (UCI). Signaling transmitted in a sidelink physical layer control channel may be known as Sidelink Control Information (SCI). Signaling may be included in a higher-layer (e.g., higher than physical layer) packet transmitted in a physical layer data channel, e.g. in a physical downlink shared channel (PDSCH), in which case the signaling may be known as higher-layer signaling, static signaling, or semi-static signaling. Higher-layer signaling may also refer to Radio Resource Control (RRC) protocol signaling or Media Access Control-Control Element (MAC-CE) signaling.

The scheduler 253 may be coupled to the processor 260. The scheduler 253 may be included within or operated separately from the T-TRP 170. The scheduler 253 may schedule uplink, downlink, sidelink, and/or backhaul transmissions, including issuing scheduling grants and/or configuring scheduling-free (e.g., “configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252, and the processing components of the receiver 254 may each be implemented by the same or different one or more processors that are configured to execute instructions stored in a memory, e.g. in the memory 258. Alternatively, some or all of the processor 260, the scheduler 253, the processing components of the transmitter 252, and the processing components of the receiver 254 may be implemented using dedicated circuitry, such as a programmed FPGA, a hardware accelerator (e.g., a GPU or AI accelerator), or an ASIC.

Although the NT-TRP 172 is illustrated as a drone only as an example, the NT-TRP 172 may be implemented in any suitable non-terrestrial form, such as satellites and high altitude platforms, including international mobile telecommunication base stations and unmanned aerial vehicles, for example. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated to avoid congestion in the drawing. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, demodulating received symbols, and decoding received symbols. In some embodiments, the processor 276 implements the transmit beamforming and/or receive beamforming based on beam direction information (e.g. BAI) received from the T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272, and the processing components of the receiver 274 may each be implemented by the same or different one or more processors that are configured to execute instructions stored in a memory, e.g. in the memory 278. Alternatively, some or all of the processor 276, the processing components of the transmitter 272, and the processing components of the receiver 274 may be implemented using dedicated circuitry, such as a programmed FPGA, a hardware accelerator (e.g., a GPU or AI accelerator), or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

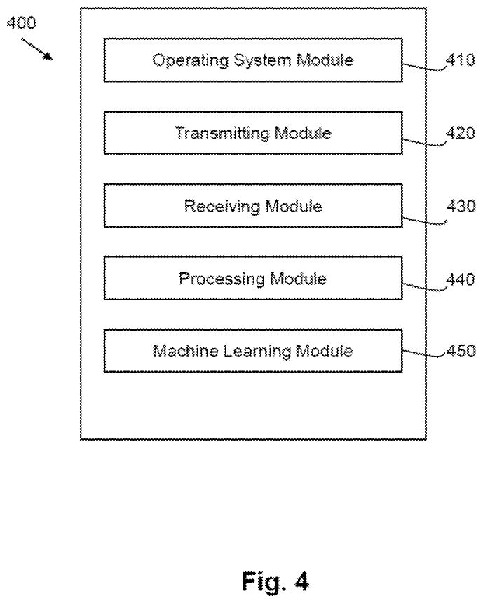

One or more steps of the embodiment methods provided herein may be performed by corresponding units or modules, according to FIG. 4. FIG. 4 illustrates units or modules in a device 400, such as in the ED 110, in the T-TRP 170, or in the NT-TRP 172. For example, the device may comprise an Operating System module 410. A signal may be transmitted by a transmitting unit or by a transmitting module 420. A signal may be received by a receiving unit or by a receiving module 430. A signal may be processed by a processing unit or a processing module 440. Other steps may be performed by an artificial intelligence (AI) or machine learning (ML) module 450. The respective units or modules may be implemented using hardware, one or more components or devices that execute software, or a combination thereof. For instance, one or more of the units or modules may be a circuit such as an integrated circuit. Examples of an integrated circuit includes a programmed FPGA, a GPU, or an ASIC. For instance, one or more of the units or modules may be logical such as a logical function performed by a circuit, by a portion of an integrated circuit, or by software instructions executed by a processor. It will be appreciated that where the modules are implemented using software for execution by a processor for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170, and the NT-TRP 172 are known to those of skill in the art. As such, these details are omitted here.

The solution described in the application is applicable to a next generation (e.g. sixth generation (6G) or later) network, or a legacy (e.g. 5G, 4G, 3G or 2G) network.

The proposed 6G System architecture is defined to support 6G XaaS services by using techniques such as Network Function Virtualization and Network Slicing. The 6G System architecture utilizes service-based interactions between 6G services.

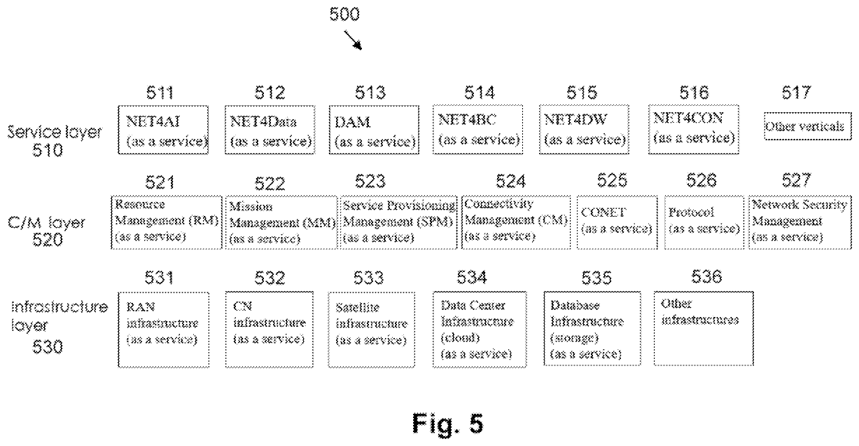

The 6G System leverages service-based architecture and XaaS concept. XaaS services in the 6G System are categorized into three layers. A 6G System conceptual structure 500 is shown in FIG. 5.

Infrastructure Layer 530 includes infrastructures supporting 6G services. Among them are wireless networks (RAN, CN) infrastructures 531 and 532, Cloud/data center infrastructures 534, satellite infrastructure 533, and storage/database infrastructures 535. Infrastructure Layer 530 may further include other infrastructures 536 including for example, sensing networks, and the like. These infrastructures can be provided by a single provider or by multiple providers.

Each of the infrastructures could have its control and management functions, denoted as C/M functions, for infrastructure management. Each of these infrastructures is one type of Infrastructure as a Service.

Control and Management (C/M) layer 520 includes control and management services of the 6G System. They are developed and deployed by using slicing techniques and utilizing resource provided by infrastructure layer. 6G services in Control and Management (C/M) layer are:
Resource Management (RM) as a Service 521 provides a capability of life-cycle management of a variety of slices and over-the-air resource assignment to wireless devices.
Mission Management (MM) as a Service 522 provides a capability to program provisioning of XaaS services at a Service Layer to provide mission services. A 6G mission is defined as a service provided to customers by the 6G System. A mission can be a type of services which is provided by a single 6G XaaS service or a type of services that needs contributions from multiple XaaS services.
Confederation Network (CONET) as a Service 525 provides a capability to enable multiple partners to jointly provide 6G services. This capability is provided by confederation formation, mutual authentication, mutual authorization among partners and negotiation of an agreement on recording and retracing selected actions performed by partners, in order to assure a trustworthy environment within 6G System operations.
Service Provisioning Management (SPM) 523 as a Service provides a capability of control and management of 6G service access by customers and provisioning of requested services. The capability is provided by unified mutual authentication, authorization and policy, key management, QoS assurance and charging between any pair of XaaS service provider and customer. The customers include end-customers not only in physical world, but also digital representatives in digital world.
Connectivity Management (CM) as a Service 524 leverages 5G connectivity management functions, but with an extension to include digital world.
Protocol as a Service 526 provides a capability to design service customized protocol stacks for identified interfaces. The protocol stacks could be pre-defined for on-demand selection, or could be designed on-demand.
Network Security 527 as a Service provides a capability for owners of infrastructures to detect potential security risks of their infrastructures.

XaaS services in C/M Layer 520 support control and management of the 6G System itself and also provide support to verticals if requested. For example, the RM service 521 may serve a RAN for over-the-air resource management and may also provide service to a vertical for the vertical's over-the-air resource allocation to its end-customers. The XaaS in C/M layer may be deployed by using slicing techniques.

Service Layer 510 includes 6G services which provide services to customers. Service Layer 510 may include:
An AI service 511 denoted as NET4AI as a Service. Artificial Intelligence service 511 provides AI capability to support a variety of AI applications.
A service of data collection, data sanitization, data analysis and data delivery is denoted as DAM as a Service 513. This service provides lifecycle management of statistic data, including acquisition, de-privatization, analysis and delivery of data which from any type of sensor, device, network function, and the like.
A service of data storage and data sharing is denoted as NET4Data as a Service 512. This service provides trustworthy storage and sharing of data for data owners, while following recognized authorities' regulations on control of identified data.
A Digital World service, denoted as NET4DW as a Service 515, provides a capability to construct, control and manage a digital realization of the physical world.
A block chain service is denoted as NET4BC as a Service 514. NET4Con as a Service 516 provides support to 6G block chain services.
Enhanced connectivity service, e.g., network for connectivity (NET4CON) as a Service 516 supports the exchange of messages and data among new 6G services.

XaaS services of the Service Layer 510 are developed and deployed by using resources provided by Infrastructure Layer 530 and by utilizing Network Function Virtualization and Slicing techniques. The capability of each 6G service is provided by its control and management functions and service specific data process functions.

In addition to supporting 6G XaaS services from Service Layer 510, the 6G System leverages the 5G System for provisioning of vertical services. The difference between 6G XaaS services and other verticals is that a vertical is a pure customer which needs other XaaS services to enable its operation, while each XaaS service provides its capabilities to 6G customers.

Any pair of XaaS services of the 6G System could also be mutual customers and providers of each other. For example, an infrastructure owner may provide its resource to XaaS services in Service Layer 510 and C/M Layer 520, and RM service 521 may need the capabilities provided by NET4AI 511, DAM 513, and NET4DW 515 in order to utilize vertical slicing in the provision of resource management services. Similarly, CONET service 525 and NET4Data service 512 may need the capability provided by NET4BC for their operation.

The key concepts of a 6G System include:
Defining basic XaaS Services by decoupling comprehensive types of services into basic XaaS services. A basic XaaS service provides a unique capability to enable a specific type of service, such as a NET4AI service, a NET4DW service, a DAM service, a NET4Data service, a Block chain service, a mission management service, amongst others.
Allowing the joint operation of the 6G System by multiple partners.
Defining a Data Plane of the 6G System including processing functions of data planes for XaaS services. Programing the interconnection of these functions, by the mission management service, enables a variety of customized customer services.
Simplifying the 6G System architecture by categorizing basic control services and management services and combining them as basic XaaS services in the Control and Management (C/M) Layer.
Defining the C/M Layer of the 6G System including C/M functions as XaaS services and optionally including 5G Control Plane (CP), such as Access and Mobility Functions (AMF).
Defining a Basic Architecture Structure (BAS) which is a unified basic structure with minimized number of interfaces and is independent from types of infrastructures.
Simplifying standardization, development and deployment of the 6G System using the BAS concept, while supporting a variety of infrastructure deployment scenarios.
Adapting to a variety of deployment scenarios by applying the BAS or a subset of it to infrastructures based on capability, capacity and requirement of the infrastructure networks.
Leveraging the Service Based Interface (SBI) interface concept and applying SBI interaction in both 6G C/M plane and 6G data plane.
Simplifying the SBI interfaces by introducing trustworthy gateways in both the C/M plane and the data plane.
Improving trustworthiness from the perspective of operators of the 6G System by introducing CONET capability, NET4BC capability and anonymous service provisioning provided by trustworthy gateways in the C/M plane and data plane of the 6G System.
Improving trustworthiness for end customer privacy protection by unified mutual authentication, Identity Management (IDM), data sanitization and the like, as provided by the SPM service, the DAM service and the 6G Block Chain service.
Simplifying roaming management for wireless devices, in the physical world and the digital world, by unifying authentication across all participating partners and customers.
Supporting multiple development paths from the 5G System to the 6G System by defining multiple architecture options without incurring much efforts due to the introduction of the BAS concept.
Supporting backward compatibility by utilizing the benefits of a Service Based Architecture (SBA) and its add-on features, allowing 5G users to use the 6G System to access 5G services.
Supporting future extensions by adding new XaaS services with minimal impact on standardization and deployment, due to the anonymous service provisioning concept implemented by trustworthy gateways in the 6G C/M plane and in the 6G data plane.

### Slice Level Resource Management

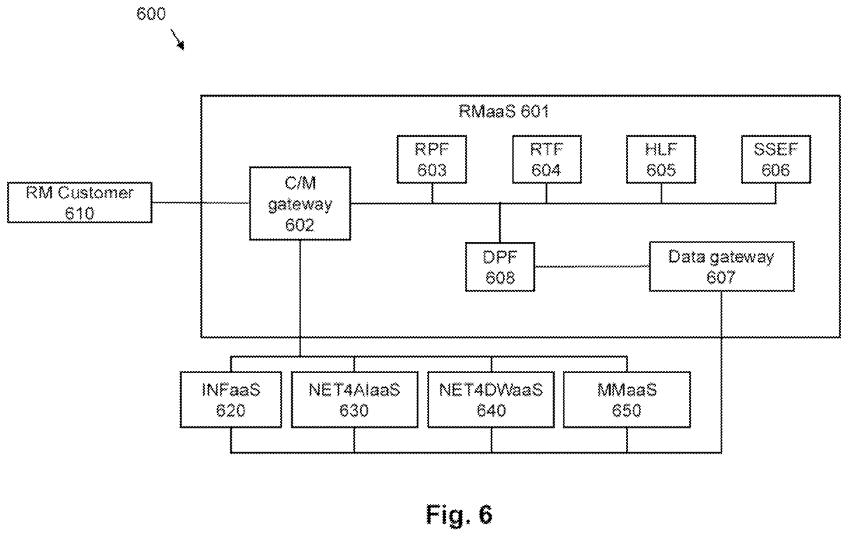

Reference is now made to FIG. 6, in which a functional architecture of slice level RMaaS according to at least some embodiments of the present disclosure is shown.

As seen in FIG. 6, the functional architecture 600 comprises various functions that are needed to support slice level RM service. Specifically, RMaaS 601 may comprise a resource provisioning function (RPF) 603, resource run-time function (RTF) 604, historical learning function (HLF) 605, scheme selection and execution function (SSEF) 606, and a data processing function (DPF) 608.

RMaaS 601 further comprises Control and Management (C/M) gateway 602, and Data gateway 607. A consumer 610 of RMaaS 601, such as, without limitation, an XaaS, may communicate with RMaaS via C/M gateway 602 through a C/M bus. RMaaS 601 may further communicate with other network services such as INFaaS 620, NET4AIaaS 630, NET4DWaaS 640, and MMaaS 650, through a C/M bus or a data bus.

Upon receiving a slice level RM request, each of the main RMaaS functions provide a specific service. For example, HLF 605 may provide historical data analysis services such as, without limitation, resource usage analysis, network state classification, and traffic demand correlation analysis, to RPF 603 and RTF 604. RPF 603 and RTF 604 are responsible for managing slice resources during slice provisioning and run-time, respectively. During slice provisioning, RPF 603 may be responsible for reserving network resources based on service requirements while RTF 604 may update the allocated resources while the network slice is in operation. SSEF 606 may be responsible for several aspects related to algorithms and schemes, such as, without limitation, scheme design, storage, update, and training. Services provided by SSEF 606 may include, without limitation, clustering, classification, resource allocation and evaluation services.

RPF 603 may be responsible for provisioning a network slice. Upon receiving a network slice provisioning request, RPF 603 assesses the RM request to determine what services are needed to complete the slice provisioning. RPF 603 may determine a strategy for completing the RM request, including, for example, using a centralized-based or a clustering-based resource allocation approach, a model-based or a data-based resource allocation approach, amongst others. RPF 603 may decide what RM strategy to implement depending on several factors, including without limitation, network size, available algorithms, and resource evaluation complexity. The related functionalities may include, without limitation:
Centralized-based RM functionality: RPF 603 may decide to manage slice resources in a centralized manner, for example in cases of a small network size. This approach relies on a central entity to manage the resources of all domains (Radio Access Network (RAN), Core Network (CN), and Telephone Network (TN)).
Clustering-based RM functionality: To address scalability in centralized RM, RPF 603 may instead request HLF 605 to provide a clustering service to form clusters with overlapping areas. The overlapping areas may be determined based on historical analysis of the data collected from base stations (BS). Data analysis may determine, for each BS, which BSs influence the neighborhood observations of the considered BS. Each cluster may include two types of areas; (1) the area on which the cluster controller takes control decisions for BSs, called control area, and (2) the area from where data is collected by the cluster controller, called information collection area.
Geographical area classification functionality: When assigning resources, RPF 603 may consider how the geographical area is divided. This can be based on access points serving the area or smaller geographical areas of specified size (e.g., grids). In this case, RPF 603 may request several services, such as, without limitation, conversion of End-to-End service requirements to geographical grid-based service requirements, conversion of geographical grid data (e.g., grid-based demand and grid-based resource usage) to a corresponding virtual grid (Vgrid)-based data (e.g., Vgrid-based demand and Vgrid-based resource usage).

RTF 604 may be responsible for updating slice resources while the network slice is in operation. Upon receiving a run-time RM request from a customer, RTF 604 updates the allocated slice resources so as to satisfy the End-to-End service requirements. Similarly to RPF 603, RTF 604 may decide to implement appropriate RM strategies including without limitation centralized-based, clustering-based, model-based, or data-based RM strategies, depending on different factors including without limitation network size, available algorithms, resource evaluation complexity, and the like. For example, due to the need to update network slice resources quickly during run-time, RTF 604 may implement an RM strategy based on distributed multi-agent-based RM with neighbor information sharing and network state classification. For example, in some embodiments of the present disclosure, each BS may comprise a trained Artificial Intelligence (AI) model such as a neural network to allocate the BS resources quickly. In this case, RTF 604 may instruct SSEF 606 to provide scheme-related services, such as training and updates, among others. The services acquired by RTF 604 may include, without limitation:
a traffic analysis service to determine a future time window for resource update;
a traffic prediction service which considers past traffic variations, and time and spatial correlation;
a traffic correlation analysis service from HLF 605 for traffic prediction;
a neighboring BS discovery service provided by HLF 605 to determine which BSs influence the neighborhood observations of the considered BS;
a network state classification service from HLF 605 to determine and classify network states so as to do training and resource updates efficiently;
a training and synchronization service from SSEF 606 for training and synchronizing episodes, training steps (AI models updates), initial states, and sampled data in a mini batch.

HLF 605 provides historical data-related services required by RPF 603, RTF 604, and SSEF 606. The main functionalities provided by HLF 605 include:
A collection functionality: This functionality may collect data needed to support the services requested by RPF 603, RTF 604, and SSEF 606. Examples of such data include without limitation: (1) processed traffic per processing node such as network functions and BSs (2) resource usage per processing node per service per network state (3) traffic statistics, such as temporal and spatial correlation (4) influence of a BS, such as scheduling, technology, and interference on neighboring BSs. The requesting function, whether RPF 603 or RTF 604, may decide, based on several factors such as resource usage statistics, resource evaluation complexity, and traffic properties, that HLF 605 should gather data per BS's coverage area or to divide the serving area into smaller areas within the BS's coverage area. Policies regarding the collected data, such as data type, granularity, and monitored entities, may also be determined by RPF 603 and RTF 604 as part of the slice level RM strategy.
An analysis functionality: This functionality may provide data analysis services to analyze collected data. The analysis may include without limitation (1) association of areas and grids to their serving BSs (a cell center grid is most likely to be served by its nearest BS, which reduces resource evaluation complexity), (2) discovery of neighboring BSs whose actions impact the considered BS (3) analysis and classification of network states and conditions (4) resource usage per unit of traffic per processing node per BS's coverage area or subarea per network state, (5) processed traffic statistics per processing node per BS's coverage area or subarea per network state, (6) classification of traffic demand profiles, based on, for example, their similarity in resource usage (7) temporal and spatial correlation of the traffic (8) combining areas with similar features and properties (e.g., similar resource usage, similar path loss, etc.) to form virtual areas (9) formation of correlated areas and grids based on traffic correlation analysis (10) formation of BS clusters including determining which BS should control the cluster, and (11) evaluation of prior decisions taken by the SSEF and future recommendations for the SSEF.

SSEF 606 may design and maintain a set of schemes and algorithms needed to provide slice level RM services. SSEF 606 may provide scheme-related services to RPF 603, RTF 604 and HLF 605. Services provided by SSEF 606 may include without limitation, clustering, classification, resource evaluation, resource modelling, and resource strategy evaluation and testing. For example, SSEF 606 may provide a BS clustering algorithm to RPF 603 and RTF 604. The clustering service may include assessing actions and decisions of BSs to capture the influence of a BS on other BSs so that RPF 603 and RTF 604 may take clustering-related decisions, such as selecting a clustering-based or a centralized-based approach. The schemes maintained within SSEF 606 may be classified according to the type of the targeted problem (e.g., clustering, classification, resource evaluation, etc.). Within this high-level classification, schemes may be further classified, for example according to whether the schemes are model-based or data-based. The schemes maintained by SSEF 606 could be exposed to a potential scheme service customer such as HLF 605, RPF 603 and RTF 604, so that they may include as part of a service request to SSEF 606, what scheme is to be used by SSEF 606. Scheme exposure may provide a list of all available schemes associated with for example, a given capability, parameters, structure, requirement, and complexity. In some embodiments of the present disclosure, SSEF 606 may be responsible for selecting a scheme. Each scheme maintained within SSEF 606 may be characterized based on, without limitation:
a type of problem it can solve (clustering, classification, resource evaluation, feature extraction, and the like);
scheme parameters and associated complexity;
structure and type of input data and output data.

In at least some embodiments of the present disclosure, SSEF 606 may include a subfunction responsible for scheme design and update. In this case, SSEF 606 may need to monitor previously designed schemes for their performance so that these schemes can be updated and their performance improved upon. Alternatively, schemes may be imported from third parties.

DPF 608 may provide data processing service to RPF 603, RTF 604, HLF 605, and SSEF 606. For example, HLF 605 may request DPF 608 to process and analyze the data collected from INFaaS 620 to provide resource usage analytics service to RPF 603 and RTF 604. In another example, DPF 608 may process data provided by NET4AIaaS 630 to gain insights on algorithm performance and requirements such as computing and storage resources usage, complexity, and scalability, amongst others.

According to at least some embodiments of the present disclosure, RPF 603 operations may comprise the following.

Create Network Slice: This operation designs and creates a network slice based on slice customer requirements and XaaS services capabilities. The consumer may be an XaaS, a service provider, or the RMaaS C/M gateway. The input may comprise a Service Level Agreement (SLA) if RPF 603 has the capability to translate an SLA to service requirements. The input may also comprise the customer's service requirements such as user distribution, coverage area, data rate, requirements per network segment, and whether the network slice may be shared or not. Slice customer requirements might also include what type of network slice is needed (e.g., network slice to support mission management, NET4AI, etc.) including the type of network functions (NFs) needed, such as a DPF, a data GW, a C/M GW, amongst others. Slice customer requirements might also include the type of the in-network processing that the network slice should support. Alternatively, the request might include types of services to be delivered by the network slice and it is then the task of the RPF to determine what NFs and DPFs are needed. The Create Network Slice operation includes (1) designing and preparing the network slice according to a slice blueprint, which may include determining the NFs and in-network processing type to initiate based on the slice blueprint, (2) checking network service availability and their capabilities, and (3) requesting that the mission manager execute network services according to an order of service execution. The output may comprise a success or rejection indicator, a reason for failure, and a network slice ID.

Delete Network Slice: This operation deletes an existing network slice and releases any resources allocated to it. The consumer may be an XaaS, a service provider, or the RMaaS C/M gateway. The input may comprise a network slice ID, and a time for deletion. The output may comprise a success or failure indicator.

According to at least some embodiments of the present disclosure, RTF 604 operations may comprise the following.

Update Network Slice: This operation updates network slice resources and policies. The consumer may be an XaaS, a service provider, an RPF, or the RMaaS C/M gateway. The input may comprise a network slice ID, service requirements, and slice-specific information such as currently allocated resources, slice loading, and resource cost. The output may comprise a success or failure indicator, a reason for failure, slice resources, and policies, such as an amount of traffic served by each network function or BS.

Delete Network Slice Update: This operation deletes a previously received update network slice request. The consumer may be an XaaS, a service provider, an RPF, or the RMaaS C/M gateway. The input may comprise a network slice ID and a time of deletion, and the output may comprise a success or failure indicator.

According to at least some embodiments of the present disclosure, HLF 605 operations may comprise the following.

Collect Data: This operation collects data needed for data analysis task such as network state classification, resource usage analysis, and the like. The consumer may be RPF 603, RTF 604, and SSEF 606. The input may comprise data identifiers (e.g., served traffic per BS, interference per BS, etc.), data location, timestamp, destination of data, and a collection period. The output may comprise a success or failure indication, a reason for failure, and collected data.

Data Analysis: This operation performs data analysis such as network state classification, BS clustering, and geographical grids combining, amongst others. The consumer may be RPF 603, RTF 604, and SSEF 606. The input may comprise an analysis type ID, data if it is already available, or data identifying information if data is to be collected by HLF 605 (e.g., data identifiers, data location, timestamp, collection period, and the like), analysis-specific parameters (e.g., for network state classification, parameters include number of classified network state groups, neighboring BS IDs, and the like), and a target of analysis result. The output may comprise the analysis results.

According to at least some embodiments of the present disclosure, SSEF 606 operations may comprise the following:

Scheme Request: This operation may provide a scheme or an algorithm to a consumer. The consumer may be RPF 603, RTF 604, and HLF 605. The input may comprise a scheme ID if the requested scheme is known to consumer, a problem ID, a scheme intent, a complexity, a scheme type (e.g., optimization-based, learning-based, and the like), and a scheme destination (e.g., a DPF for a scheme to be executed by the DPF). The output may comprise the requested scheme if available, success (if scheme is available) or failure indication (if requested scheme is not available), and a location of the requested scheme if the requested scheme is not available and could be retrieved from a 3rd party.

Update Library: This operation may be used to request that SSEF 606 to update its library and add more schemes and algorithms, or to update the stored schemes. The consumer may be RMaaS C/M gateway 602, RPF 603, RTF 604, and HLF 605. The input may comprise a problem description, a problem ID, a scheme description, a scheme intent, a required complexity, and a scheme location. The output may comprise a success or failure indicator.

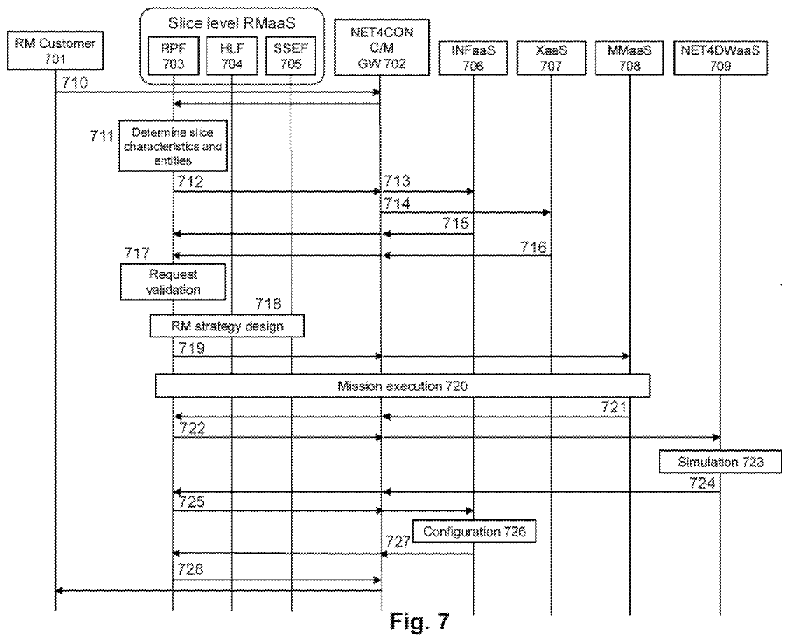

Reference is now made to FIG. 7, in which a procedure for network slice provisioning according to at least one embodiment of the present disclosure is illustrated. This procedure may be used for creating a network slice for a consumer utilizing the capabilities of XaaS services.

At the outset of the procedure illustrated in FIG. 7, a NET4CON C/M may have established and configured C/M gateways so that XaaS services may communicate securely. Also, the capabilities of the XaaS services are exposed to the mission manager (MMaaS).

As seen in FIG. 7, a slice customer 701, for example an XaaS, may send a request to create a network slice 710 to RPF 703. For example, request 710 may be received by NET4CON C/M gateway 702 and forwarded to RPF 703. Request 710 may comprise, without limitation, (1) service requirements such as user distribution, data rate, coverage area, slice type, required NFs or services provided by the slice, in-network data processing type and requirements, and computing and storage requirements, (2) monitoring information exposure during slice operation such as slice status exposure and Key Performance Indicators (KPI) exposure, and (3) slice characteristics (for example whether the slice is shared or not).

Upon receiving request 710, RPF 703 may assess request 710 to determine slice characteristics including but not limited to what NFs and DPFs to initialize, network topology, and whether slice resources are to be shared or not. RPF 703 may also determine what XaaS services are needed in order to complete request 710, as illustrated by block 711. Examples of XaaS services that might be involved include, without limitation:
Infrastructure as a Service (INFaaS) 706 may provide the infrastructure and resources needed to create the network slice. INFaaS 706 may include without limitation Radio Access Network as a Service (RANaaS), Core Network as a Service (CNaaS), and Satellite as a Service (SATELLITEaaS).
DAM as a Service (DAMaaS) may provide data-related services to RPF 703 such as collection and delivery of access points and network functions' historical data.
NET4AI as a Service (NET4AIaaS) may provide AI model training and inferencing to RPF 703.
Mission Management as a Service (MMaaS) 708 may provide network-based computation to the RMaaS functions. The RM mechanism may be executed as tasks or submissions managed by MMaaS 708.

For the purposes of FIG. 7, DAMaaS and NET4AIaaS are deemed to be included in XaaS 707.

RPF 703 may then send a request for service type availability and capability exposure 712 to the XaaS services determined at block 711. Request 712 aims to provide RPF 703 with the types of the services that can be provided by XaaS services and the capabilities of XaaS services, including without limitation, available resources of INFaaS 706, AI training & inferencing capability of NET4AIaaS, and data collection & delivery capability of DAMaaS. Request 712 may be forwarded to INFaaS 706 through message 713, and to XaaS 707 through message 714. INFaaS 706 may respond with message 715 and XaaS 707 may respond with message 716.

Upon receiving responses 715 and 716, RPF 703 may initially validate request 710, as illustrated by block 717, to determine whether the request can be satisfied considering the available services, capabilities of the XaaS services and the functional capability of the slice-level RMaaS.

RPF 703 in conjunction with HLF 704 and SSEF 705 may then design an RM mechanism as illustrated by block 718. This may comprise, without limitation, determining (1) what approach to implement to evaluate the resources, e.g., model-based or data-based approach, centralized or distributed RM strategy, and clustering-based approach or not, (2) what resource allocation algorithms to use, (3) what historical learning analysis is needed from HLF 704 (e.g., BS clustering, grid combining, resource usage analysis, and the like). This operation may further comprise preparing mission information such as mission graph, specification, intent, and the like, as described in greater detail below.

Message 719 may then be sent by RPF 703 to MMaaS 708 (in particular, to the Mission Control Function (MCF) inside MMaaS 708) to trigger the mission execution. Request 719 may include information identifying the mission such as a mission ID, a mission graph, a mission intent, and mission execution requirements such as maximum execution time. More details regarding message 719 are provided below.

Then, as illustrated by block 720, mission execution may proceed. Mission execution may include mission initialization, coordination and termination. During mission execution, computations for tasks and submissions belonging to the mission identified by RPF 703 may be executed. MMaaS 708 may interact with XaaS services 707 in order for each XaaS to provide the required service. Mission execution results may include the amount of resources and policies needed to satisfy the RM request. As a non-limiting example, this may include the average amount of traffic served by each access point and network functions and QoS parameters supported by the slice.

MMaaS 708 (specifically, the MCF) may then send message 721 to RPF 703. Message 721 may indicate completing the mission execution requested by RPF 703 in request 719.

RPF 703 may then send request 722 to simulate the resource allocation decisions by the NET4DWaaS 709. Request 722 may include simulated physical entities-related information such as their IDs, specifications, descriptions, resource allocation decisions, and simulated service requirements, amongst others.

Then, at block 723, NET4DWaaS 709 may simulate the physical environment, including physical objects such as BSs, users, NFs, and resource allocation decisions.

NET4DWaaS 709 may then send the simulation process results including expected performance to RPF 703 with message 724.

Message 725 may then be sent by RPF 703 to INFaaS 706. Message 725 may include the resource amounts and policies needed to satisfy RM request 710.

Upon receiving message 725, INFaaS 706 may configure its resources according to the policies and resource amounts included in message 725, as illustrated by block 726.

INFaaS 706 may then send an acknowledgment message 727 to RPF 703 to acknowledge that the infrastructure was successfully configured.

RPF 703 may then inform the slice customer 701 of the results with message 728. If the request is rejected, message 728 may include a reason for the rejection, suggestions to satisfy RM request 710 (e.g., modifying service requirement). If the request is accepted, RPF 703 message 728 may comprise an acknowledgment to slice customer 701 that the slice is ready for operation.

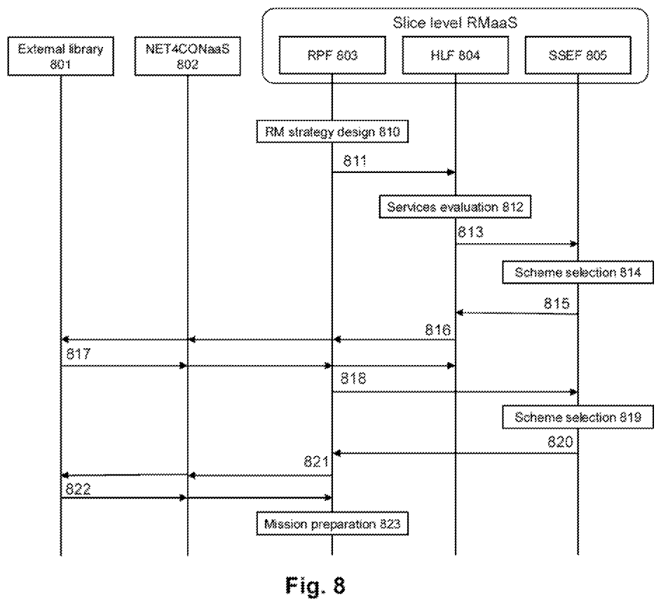

Reference is now made to FIG. 8 which illustrates a method for selecting a resource management strategy according to at least one embodiment of the present disclosure. Specifically, the method illustrated in FIG. 8 corresponds to block 718 of FIG. 7.

As seen in FIG. 8, RPF 803 initiates the RM strategy design for allocating resources by considering the capabilities of HLF 804 and SSEF 805, as illustrated by block 810. For example, RPF 803 may consider the services that can be delivered by HLF 804, the available algorithms in SSEF 805, as well as the service types that can be provided by XaaS services and their capabilities such as INFaaS, DAMaaS, amongst others. The strategy may include, without limitation (1) what approach to implement to evaluate resources, such as a model-based or a data-based approach, a centralized or a distributed RM strategy, a clustering-based approach or not, etc., (2) what resource allocation algorithms to use, (3) what historical learning analysis is needed from HLF 804, such as for example BS clustering, grid combining, resource usage analysis, and the like, and (4) available resources of the infrastructure.

RPF 803 may then send message 811 to HLF 804, indicating the services that are needed by RPF 803 from HLF 804. Message 811 may include, without limitation, historical resource usage analysis, traffic demand analysis, BS clustering, and grid combining.

Upon receiving message 811, HLF 804 may perform historical learning services evaluation, as illustrated by block 812. Specifically, HLF 804 may determine the subservices and subtasks required to deliver the services tasks acquired by RPF 803. HLF 804 may also determine the requirements of the subservices, the subtasks, and the algorithms needed to provide such services to RPF 803.

HLF 804 may then send message 813 to SSEF 805. Message 813 may include information identifying requested algorithms. Such information may include, without limitation, an algorithm ID (if known), an algorithm intent, a capability, and a complexity. HLF 804 may request information about one or multiple algorithms from SSEF 805.

Upon receiving message 813, SSEF 805 may select algorithms according to the information included in message 813, as illustrated by block 814.

SSEF 805 may then provide information about the schemes requested by HLF 804 to HLF 804 in message 815. Message 815 may include, without limitation, a scheme structure and parameters, complexity, run time information, and scheme temporal and spatial validity. If a requested scheme is not available, a relevant message may be sent to indicate the unavailability of the requested scheme.

HLF 804 may then send message 816, through RPF 803, to an external algorithm library 801 if some requested algorithms are not available in SSEF 805. Message 816 may comprise, without limitation, algorithm intent, capability, and complexity, for one or multiple algorithms.

External library 801 may then respond with message 817, which includes information about the schemes requested by HLF 804 in message 816. Specifically, message 817 may include, without limitation, the requested scheme structure and parameters, complexity, run time information, and scheme temporal and spatial validity.

RPF 803 may then send message 818 to SSEF 805. Message 818 may include information identifying one or more algorithms requested by RPF 803, such as an algorithm ID (if known), an algorithm intent, a capability, and a complexity.

Upon receiving message 818, SSEF 805 may select algorithms according to the information included in message 818, as illustrated by block 819. Notably, block 819 is distinct from block 814 in that SSEF 805 now selects algorithms based on a message from RPF 803, whereas at block 814, the SSEF selected algorithms based on a message from HLF 804.

SSEF 805 may then send message 820 to RPF as a response. Message 820 may include information about the schemes requested by RPF 803 in message 818, comprising, for example, the requested scheme structure, and parameters, complexity, run time information, and scheme temporal and spatial validity. If some requested schemes are not available, a relevant message may be sent to indicate the unavailability of the requested schemes.

When some of the requested algorithms are not available in SSEF 805, RPF 803 may send message 821 to external algorithm library 801. Message 821 may include, without limitation, algorithm intent, capability, and complexity.

Upon receiving message 821, external library may respond with message 822 including information about the schemes requested by RPF 803 in message 821. Message 822 may include the requested schemes, comprising a structure, and parameters, complexity, run time information, and scheme temporal and spatial validity.

RPF 803 may then prepare and determine the information identifying the mission, which may include, without limitation, a mission ID, an intent, involved participants, and a mission graph, as illustrated by block 823.

Based on the above, and specifically FIG. 7, an RPF, which represents a mission user, may interact with an Mission Control Function (MCF) of a MMaaS to trigger a resource allocation mission involving several XaaS services, such as for example an INFaaS, a NET4AIaaS, a DAMaaS, as well as other services provided by the RMaaS's internal functions like an HLF and an SSEF. Each of the XaaS services involved may be represented as a single mission block (MB) or composed into several MBs. A message sent by the RPF to the MCF (such as message 719 of FIG. 7) may include mission-related information that is needed for the MMaaS to complete the mission goal successfully. Alternatively, the MMaaS may interact directly with XaaS services and fetch some of the mission-related information from XaaS services. Example details of RM-specific mission information according to at least some embodiments of the present disclosure are provided in Table 1.

| Name | Description |
|---|---|
| MID | Identifier of the slice-level RM mission. |
| Temporal validity | Indicates when the mission is valid or available, such as a time of the |
| condition | day, week, or month. |
| Spatial validity | Indicates where the mission is valid or available by defining a service |
| condition | area of the mission, e.g., due to network resource availability constraints |
| | or data processing regulation constraints. |
| Reusability | Indicates whether the mission information is reusable. |
| indication | |
| Application | Indicates a PLMN, a private network, or RANs operated by specific |
| indication | operator, amongst others. This value may be void if the mission |
| | information is indicated as being reusable. |
| Mission intent | Indicates a mission goal, namely a goal that the mission is meant to |
| | achieve. This information may be provided by the RPF to the MMaaS |
| | and may include: |
| | General service information (applicable to all services involved), |
| | including a service ID, a target service type such as DAMaaS, |
| | NET4AIaaS, and INFaaS, and a service order. |
| | Service-specific information: |
| | 1. DAMaaS information |
| | Data collection type: traffic data; resource usage data |
| | Data collection location |
| | Data collection time |
| | Data processing method: calculate spatial distribution |
| | Output data granularity |
| | 2. INFaaS information |
| | Resources type (radio, computing, storage) |
| | Temporal resource availability (granularity could be |
| | hours, day, week, etc.) |
| | Resource cost and budget |
| | Resource sharing indicator (whether sharing is allowed |
| | or not) |
| | 3. NET4AIaaS information |
| | Algorithm ID |
| | Algorithm type: clustering, multi-agent actor-critic, deep |
| | Q learning, etc. |
| | Algorithm-specific information: structure, parameters, |
| | etc. |
| | 4. NET4DWaaS information |
| | Simulation time-length |
| | Configuring resource scheduling scheme |
| | Data processing requirements: calculate per- |
| | batch/iteration resource scheduling scheme performance |
| | matrix; calculate traffic pattern within the simulation |
| | time-length; etc. |

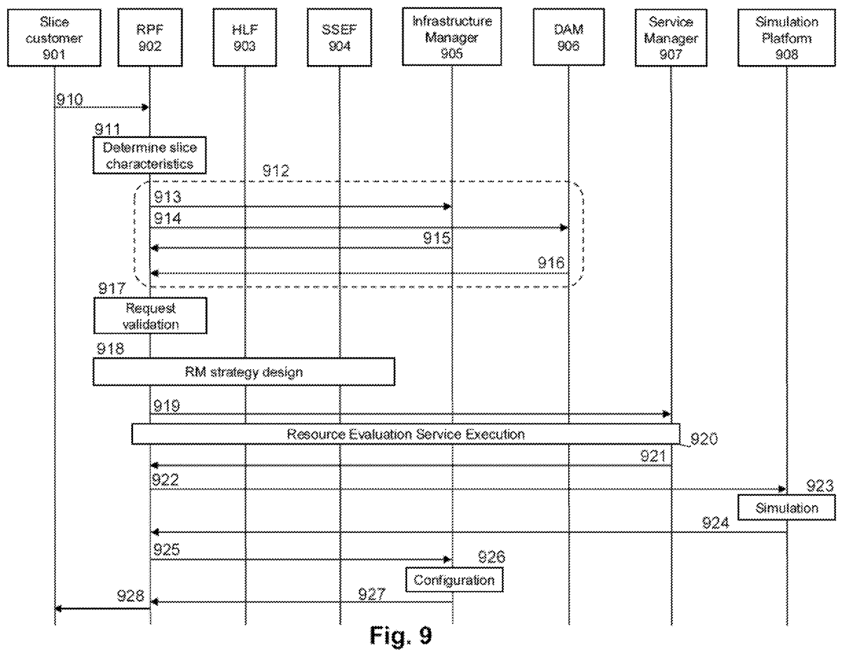

Reference is now made to FIG. 9, in which a method for processing a request for a network slice according to at least one embodiment of the present disclosure is illustrated.

As seen in FIG. 9, a slice customer 901 may send a request 910 to create a network slice to RPF 902. Request 910 may comprise, without limitation, (1) service requirements (e.g., user distribution, data rate, coverage area, slice type, required NFs or services provided by the slice, in-network processing type and requirements, computing requirements, processing type, etc.), (2) monitoring information exposure during slice operation such as slice status exposure and Key Performance Indicators (KPI) exposure, and (3) slice characteristics (for example whether the slice is shared or not).

Upon receiving request 910, RPF 902 may assess request 910 to determine slice characteristics and what network services are needed in order to complete request 910, as illustrated by block 911. Examples of network services that might be involved include, without limitation: infrastructure service (e.g., RAN, and CN), data collection service which may provide data-related services to RPF 902 such as collection and delivery of access points and network functions' historical data, service management service which may provide network-based computation to RPF 902. The RM mechanism may be executed as tasks or subtasks managed by service manager 907.

The method then proceeds to block 912 where RPF 902 may then send requests 913 and 914 for capability exposure to the network services determined at block 911 to infrastructure manager 905 and DAM 906, respectively. Requests 913 and 914 aim to provide RPF with the available network services and capabilities of network services, including without limitation, available resources of infrastructure, and data collection & delivery capability of DAM 906, which may be received in responses 915 and 916.

RPF 902 may then validate request 910, as illustrated by block 917, to determine whether the request can be satisfied considering the availabilities and capabilities of the network services.

RPF 902 in conjunction with HLF 903 and SSEF 904 may then design an RM mechanism as illustrated by block 918. This may comprise, without limitation, determining (1) what approach to implement to evaluate the resources, e.g., model-based or data-based approach, centralized or distributed RM strategy, and clustering-based approach or not, (2) what resource allocation algorithms to use, (3) what historical learning analysis is needed from HLF 903 (e.g., BS clustering, grid combining, resource usage analysis, and the like). This operation may further comprise preparing resource evaluation service information such as a service graph, a specification, an intent, and the like, as described in greater detail below.

Message 919 may then be sent by RPF 902 to service manager 907 to trigger a resource evaluation service. Request 919 may include information identifying the service such as a service ID, a service graph, a service intent, and service execution requirements such as maximum execution time. More details regarding message 919 are provided below.

Then, as illustrated by block 920, execution of the resource evaluation service may proceed. The resource evaluation service execution may include service initialization, coordination and termination. During service execution, computations for tasks belonging to the resource evaluation service identified by RPF are executed. Service manager 907 may interact with the identified network services in order for each network service to provide the required service.

Service manager 907 may then send message 921 to RPF 902. Message 921 may indicate completion of the resource evaluation service requested by RPF 902.

RPF 902 may then send request 922 to simulation platform 908 to simulate resource allocation decisions. Request 922 may include simulated physical entities-related information such as their IDs, specifications, descriptions, resource allocation decisions, and simulated service requirements, amongst others.

Then, at block 923, simulation platform service 908 may simulate the physical environment, including physical objects such as BSs, users, NFs, and resource allocation decisions.

Simulation platform service 908 may then send the simulation process results including expected performance to RPF 902 with message 924.

Message 925 may then be sent by RPF 902 to the infrastructure manager 905. Message 925 may include an amount of resources and policies needed to satisfy the RM request 910. As a non-limiting example, this may include the average amount of traffic served by each access point and network functions and QoS parameters supported by the slice.

Upon receiving message 925, infrastructure manager 905 may configure its resources according to the policies and resource amounts included in message 925, as illustrated by block 926.

Infrastructure manager 905 may then send an acknowledgment message 927 to RPF 902 to acknowledge that the infrastructure was successfully configured.

RPF 902 may then inform slice customer 901 of the results with message 928. If the request is rejected, message 928 may include a reason for the rejection, suggestions to satisfy request 910 (e.g., modifying service requirements). If the request is accepted, message 928 may comprise an acknowledgment to slice customer 901 that the slice creation is completed.

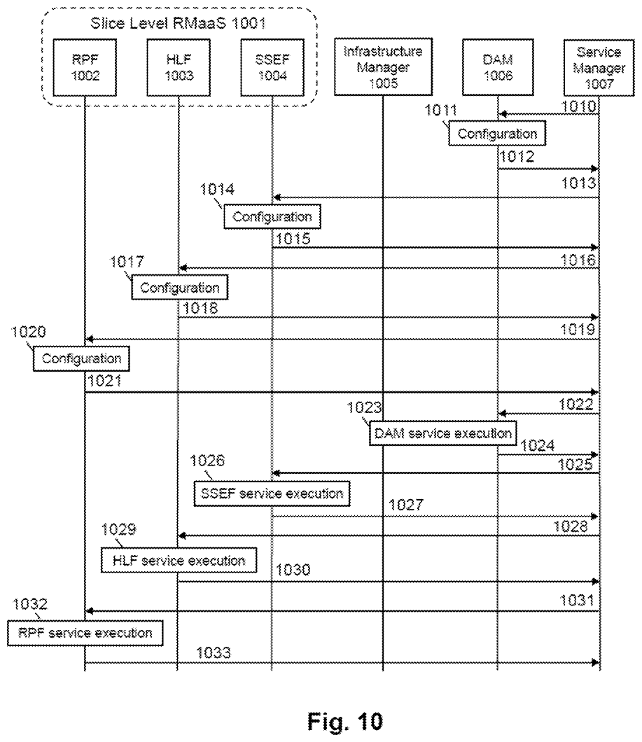

Reference is now made to FIG. 10, in which execution of resource evaluation according to at least some embodiments of the present disclosure is illustrated. Specifically, FIG. 10 illustrates in detail the process of block 920 from FIG. 9.

As seen in FIG. 10, service manager 1007 sends message 1010 to configure DAM 1006. Message 1010 may include data source, data type, data granularity, collection time, data location, and data destination. At block 1011, DAM 1006 is configured and prepared to provide the service as instructed by service manager 1007. With message 1012, DAM 1006 responds to service manager 1007 acknowledging configuration completion.

Service manager 1007 also sends message 1013 to configure SSEF 1004. Message 1013 may include a type of requested algorithm, an algorithm ID (if known), an algorithm intent, a capability, and a complexity. Service manager 1007 may send information identifying one or multiple algorithms. At block 1014, SSEF 1004 prepares the algorithms as per the instructions received from service manager 1007. This may include algorithm training, update, and loading. Then, SSEF 1004 sends an acknowledgment message 1015 to service manager 1007 acknowledging configuration completion.

Service manager 1007 also sends message 1016 to configure HLF 1003. Message 1016 may include, without limitation, analytics type, data source, analytics destination, and analytics algorithm. At block 1017, HLF 1003 is configured and prepared to provide the service as instructed by service manager 1007. With message 1018, HLF 1003 responds to service manager 1007 acknowledging configuration completion.

Service manager also sends message 1019 to configure RPF 1002. Message 1019 may include an acknowledgment that the resource evaluation service tasks determined by RPF 1002 (e.g., DAM, HLF, and SSEF services) are configured and ready to run. It may also include new information for the resource evaluation service that RPF 1002 has to consider when running the RPF task. For example, service manager 1007 may decide that granularity of data provided by DAM 1006 or complexity of the algorithm provided by SSEF 1004 may require additional computing and storage resources to accommodate DAM and SSEF services. At block 1020, RPF 1002 is configured and prepared to provide the service as instructed by service manager 1007. With message 1021, RPF 1002 responds to service manager 1007 acknowledging configuration completion.

Service manager 1007 then sends message 1022, instructing DAM 1006 to start DAM service. At this time, DAM 1006 may start collecting and preparing the data as shown in block 1023. When the data is ready, DAM sends an acknowledgment message 1024 to service manager 1007.

Service manager 1007 also sends an execution message 1025 to SSEF 1004 to start SSEF service execution. At block 1026, SSEF 1004 loads the algorithm as per the instructions received from service manager 1007. When the algorithm is sent to RPF 1002, SSEF 1004 sends message 1027 to the service manager acknowledging sending the algorithm.

Service manager 1007 also sends execution message 1028 to HLF 1003 to start HLF service execution as shown in block 1029. When the HLF service is provided to RPF 1002, HLF 1003 sends message 1030 to service manager 1007 acknowledging providing the HLF service to RPF 1002.

Service manager 1007 then sends an execution message 1031 to RPF 1002 to start RPF service execution. At block 1032, RPF 1002 executes the RPF service, i.e., the resource evaluation service and runs the algorithm received from SSEF 1004. When the RPF task is completed, RPF 1002 sends message 1033 to service manager 1007 acknowledging completion of the RPF task.

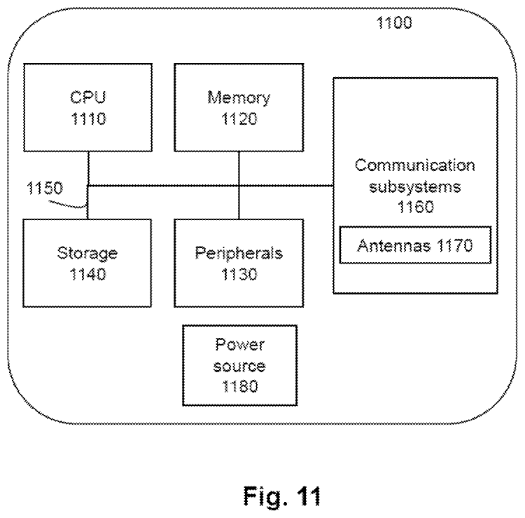

The above functionality may be implemented on any one or combination of computing devices. FIG. 11 is a block diagram of a computing device 1100 that may be used for implementing the devices and methods disclosed herein. Specific devices may utilize all of the components shown, or only a subset of the components, and levels of integration may vary from device to device. Furthermore, a device may contain multiple instances of a component, such as multiple processing units, processors, memories, transmitters, receivers, etc. The computing device 1100 may comprise a central processing unit (CPU) 1110, memory 1120, a mass storage device 1140, and peripherals 1130. Peripherals 1130 may comprise, amongst others one or more input/output devices, such as a speaker, microphone, mouse, touchscreen, keypad, keyboard, printer, display, network interfaces, and the like. Communications between CPU 1110, memory 1120, mass storage device 1140, and peripherals 1130 may occur through one or more buses 1150.

The bus 1150 may be one or more of any type of several bus architectures including a memory bus or memory controller, a peripheral bus, video bus, or the like. The CPU 1110 may comprise any type of electronic data processor. The memory 1120 may comprise any type of system memory such as static random-access memory (SRAM), dynamic random-access memory (DRAM), synchronous DRAM (SDRAM), read-only memory (ROM), a combination thereof, or the like. In an embodiment, the memory 1120 may include ROM for use at boot-up, and DRAM for program and data storage for use while executing programs.

The mass storage device 1140 may comprise any type of storage device configured to store data, programs (e.g. instructions or code), and other information and to make the data, programs, and other information accessible via the bus. The mass storage device 1140 may comprise, for example, one or more of a solid-state drive, hard disk drive, a magnetic disk drive, an optical disk drive, or the like. The memory 1120 or mass storage 1140 may store instructions, which when executed by a processor or processing unit, cause or configure the computing device 1100 to perform any of the methods described herein.

Computing device 1100 may further comprise a communications subsystem 1160 for communicating with other computing devices or for connecting computing device 1100 to a computer network. Communications subsystem 1160 may comprise one or more network interfaces (not shown), which may comprise wired links, such as an Ethernet cable or the like, and/or wireless links to access nodes or different networks. The network interface allows the processing unit to communicate with remote units via the networks. For example, the network interface may provide wireless communication via one or more transmitters/transmit antennas 1170 and one or more receivers/receive antennas 1170. In an embodiment, the processing unit is coupled to a local-area network or a wide-area network, for data processing and communications with remote devices, such as other processing units, the Internet, remote storage facilities, or the like.

Computing device may further comprise a power source 1180.

The present disclosure may be implemented on a computing device such as exemplary computing device 1100. Computing device 1100 may be a network element of a telecommunications network, such that the network element may be connected to other network elements of the telecommunication network, where all network elements form the telecommunication network. The network element may also receive communications from client devices connected to the telecommunication network and provide services to such client devices.

Through the descriptions of the preceding embodiments, the teachings of the present disclosure may be implemented by using hardware only or by using a combination of software and hardware. Software or other computer executable instructions for implementing one or more embodiments, or one or more portions thereof, may be stored on any suitable computer readable storage medium. The computer readable storage medium may be a tangible or non-transitory medium such as optical (e.g., CD, DVD, Blu-Ray, etc.), magnetic, hard disk, volatile or non-volatile, solid state, or any other type of storage medium known in the art.

Additional features and advantages of the present disclosure will be appreciated by those skilled in the art.

The structure, features, accessories, and alternatives of specific embodiments described herein and shown in the Figures are intended to apply generally to all of the teachings of the present disclosure, including to all of the embodiments described and illustrated herein, insofar as they are compatible. In other words, the structure, features, accessories, and alternatives of a specific embodiment are not intended to be limited to only that specific embodiment unless so indicated.

Moreover, the previous detailed description is provided to enable any person skilled in the art to make or use one or more embodiments according to the present disclosure. Various modifications to those embodiments will be readily apparent to those skilled in the art, and the generic principles defined herein may be applied to other embodiments without departing from the spirit or scope of the teachings provided herein. Thus, the present methods, systems, and or devices are not intended to be limited to the embodiments disclosed herein. The scope of the claims should not be limited by these embodiments, but should be given the broadest interpretation consistent with the description as a whole. Reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims.

Furthermore, nothing herein is intended as an admission of prior art or of common general knowledge. Furthermore, citation or identification of any document in this application is not an admission that such document is available as prior art, or that any reference forms a part of the common general knowledge in the art. Moreover, nothing disclosed herein is intended to be dedicated to the public regardless of whether such disclosure is explicitly recited in the claims.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A method at a network element, comprising:
receiving, from a slice customer, a request for creation of a network slice;
identifying network services required to satisfy the request, wherein the network services include at least one of an Artificial Intelligence (AI) provisioning service, a data collection service, or a historical learning service;
preparing service information required for a service manager to evaluate resource requirements for the network slice, the service information indicating an order of the network services to be executed;
sending the service information to the service manager, wherein the service manager instructs network entities to perform the network services according to the order of execution of the network services;
receiving, from the service manager, AI algorithms, historical information, and data from the network services;
running the AI algorithms utilizing the historical information and the data from the network services to determine an amount of resources required to satisfy the request;
sending, to an infrastructure manager, a configuration request, the configuration request indicating the amount of resources;
receiving, from the infrastructure manager, a response to the configuration request; and
sending, to the slice customer, the response to the configuration request.

2. The method of claim 1, wherein the network services further comprise at least one of connectivity services, service management services, or simulation services.

3. The method of claim 1, further comprising:
requesting, from each of the network services, corresponding available network service types, corresponding capability information, and corresponding resource availability.

4. The method of claim 3, further comprising:
validating, based on the corresponding available network service types and the corresponding capability information for each of the network services, that the request can be satisfied by each of the network services.

5. The method of claim 1, further comprising:
selecting a strategy, the strategy comprising at least one of: a first selection of a model-based approach or a data-based approach, a second selection of a centralized approach or a distributed approach, a third selection of whether to use clustering, a fourth selection of resource allocation algorithms, or a fifth selection of a historical learning analysis.

6. The method of claim 1, wherein the configuration request indicates an average volume of traffic for each access point and each network function, a Quality of Service (QoS) parameter, and a time indication for the execution of a network service of the network services.

7. The method of claim 1, further comprising:
sending, to a simulation platform, a simulation request to simulate the network slice, the simulation request indicating network element identifiers, network element specifications, in-network data processing types, service requirements to be satisfied by the network slice, and resource allocation decisions; and
receiving a response to the simulation request, the response indicating an expected performance of resource assignment.

8. The method of claim 5, wherein the selecting the strategy comprises:
requesting information of one or more algorithms from the AI provisioning service, wherein the information indicates an algorithm identifier, an algorithm type, a complexity, parameters, or run time information.

9. The method of claim 8, further comprising:
receiving, from the AI provisioning service, an indication that an algorithm is not available; and
requesting information associated with the algorithm from an external library.

10. The method of claim 1, wherein the service information further indicates at least one of a service identifier, an intent for a network service of the network services, network services tasks identifiers, a temporal and spatial validity, a reusability indicator, a data type, a data source and location, a collection time, a data processing method, an output data granularity, a resources type, a temporal resource availability, a resource cost and budget, a resource sharing indicator, an AI algorithm ID, an algorithm type, a structure, parameters, or a complexity.

11. The method of claim 1, wherein the order of the network services is prepared according to a slice blueprint.

12. The method of claim 1, further comprising:
preparing an online testbed for testing whether the amount of resources is sufficient to satisfy slice requirements.

13. The method of claim 7, wherein the simulation platform comprises digital representations of network functions and digital representations of the network entities, the digital representations of the network entities comprising a current state of the network entities.

14. The method of claim 1, further comprising:
receiving, from the AI provisioning service, AI algorithms;
receiving, from the data collection service, network data; and
receiving, from the historical learning service, the historical information and analytics.

15. The method of claim 1, wherein at least one network service of the network services is provided by an associated network function.

16. The method of claim 2, wherein the connectivity services provide exchange and transport of messages and data among network functions.

17. The method of claim 2, wherein the service management services provide coordination of execution of the network services according to the order of the network services.

18. The method of claim 2, wherein the simulation services are provided by a simulation service entity for testing a performance of the network slice.

19. A network element comprising:
one or more processors; and
a non-transitory computer readable storage medium storing instructions that, when executed by the one or more processors, cause the network element to perform:
receiving, from a slice customer, a request for creation of a network slice;
identifying network services required to satisfy the request, wherein the network services include at least one of an Artificial Intelligence (AI) provisioning service, a data collection service, or a historical learning service;
preparing service information required for a service manager to evaluate resource requirements for the network slice, the service information indicating an order of the network services to be executed;
sending the service information to the service manager, wherein the service manager instructs network entities to perform the network services according to the order of execution of the network services;
receiving, from the service manager, AI algorithms, historical information, and data from the network services;
running the AI algorithms utilizing the historical information and the data from the network services to determine an amount of resources required to satisfy the request;
sending, to an infrastructure manager, a configuration request, the configuration request indicating the amount of resources;
receiving, from the infrastructure manager, a response to the configuration request; and
sending, to the slice customer, the response to the configuration request.

20. A non-transitory computer readable storage medium having stored thereon executable code for execution by at least one processor of a network element, the executable code comprising instructions to cause the network element to perform:
receiving, from a slice customer, a request for creation of a network slice;
identifying network services required to satisfy the request, wherein the network services include at least one of an Artificial Intelligence (AI) provisioning service, a data collection service, or a historical learning service;
preparing service information required for a service manager to evaluate resource requirements for the network slice, the service information indicating an order of the network services to be executed;
sending the service information to the service manager, wherein the service manager instructs network entities to perform the network services according to the order of execution of the network services;
receiving, from the service manager, AI algorithms, historical information, and data from the network services;
running the AI algorithms utilizing the historical information and the data from the network services to determine an amount of resources required to satisfy the request;
sending, to an infrastructure manager, a configuration request, the configuration request indicating the amount of resources;
receiving, from the infrastructure manager, a response to the configuration request; and
sending, to the slice customer, the response to the configuration request.
